(19) United States
(12) Patent Application Publication
(10) Pub. No.: US 2011/0087600 A1
(43) Pub. Date: Apr. 14, 2011

(54) METHOD TO MANAGE PROTECTED FILE TRANSFERS BETWEEN PORTABLE MEDIA DEVICES

(75) Inventors: Arthur L. Cohen, Cupertino, CA (US); John Glissman, Manila (PH); John Haggis, San Jose, CA (US); Martin Cohen, Hatboro, PA (US)

(73) Assignee: AERIELLE TECHNOLOGIES, INC., Mountain View, CA (US)

(21) Appl. No.: 12/377,781

(22) PCT Filed: Aug. 15, 2007
(86) PCT No.: PCT/US2007/075979

§ 371 Date: Dec. 10, 2010

Related U.S. Application Data
(60) Provisional application No. 60/822,458, filed on Aug. 15, 2006.

(51) Int. Cl. G06Q 30/00; H04L 9/28

(52) U.S. Cl. 705/51; 705/26.25

(57) ABSTRACT

A method to authorize, facilitate, and mediate transfer of DRM protected files from one portable multimedia player (1050) to another portable multimedia player (1080), while ensuring appropriate royalty payments are made to appropriate Copyright Owners A source i2i device includes a file transfer counting mechanism for monitoring and disabling the transfer of digital files between portable digital media devices, and further includes hardware for providing a secure Internet interface (1020) capable of connecting the source device a Credit Vendor server (1040) via a network-connected computer (1070) A Credit Vendor (1000) pays a fee to a DRM File Source Company (1010) to obtain virtual credits for transferring DRM files The user connects the source i2i device to the Credit Vendor server (1040) via a global computer network and downloads virtual credits, which authorize and enable the transfer of content between the source i2i device and a target i2i device The Credit Vendor (1000) then pays appropriate royalties to the Copyright holders.

### BACKGROUND OF THE INVENTION

1. Technical Field

The present invention is a business method implementing the hardware, firmware, software, Internet interface, and management techniques that allow a direct transfer of media content between portable media players, while accounting for and ensuring that any royalty payments required by law are provided to owners of copyrights in protected content.

2. Background Art

Portable media players and media-based mobile phones, and combinations thereof, have become increasingly popular among general consumers. Examples include Apple Computer's IPOD® family, the H10 and U10 devices produced and sold by IRIVER®, and a multitude of similar offerings from Creative Labs, Microsoft, SanDisk, Motorola, Nokia and many others. These devices are capable of storing and playing back audio, still pictures, and even full movies, all in a variety of formats. Loading content onto these devices typically entails having the device interface with a personal computer (“PC”), which is then connected to the Internet, which functions as the routing infrastructure for transferring the sought after files.

However, it is awkward and cumbersome to employ computers to mediate such file transfers, and frequently such transfers are simply prevented by digital rights management (“DRM”) technology and/or other digital file copy protection mechanisms. The popularity of these portable media players has resulted in situations in which several family members each own more than one portable media device, and there has thus arisen a need to facilitate the transfer of media content between portable media players.

### DISCLOSURE OF INVENTION

The present inventors have devised several novel devices and platforms in a family of products for use in carrying out the inventive method. These devices (referred to herein as “i2i” devices) enable convenient transfer of content from one media player to another without the inconvenience of having to use a home or laptop computer system as the sole medium between the portable media devices. Exemplary i2i devices, which include inventive hardware, features and designs, are described in previously filed International Patent Application, entitled, Method and Apparatus for Wired/Wireless Transfer of Content and/or Data Between Multimedia Players, filed 27 Feb. 2007 (27 Feb. 2007), International Patent Application Serial Number PCT/US07/62910, which is incorporated in its entirety by reference herein. The preferred embodiments of the inventive apparatus disclosed in the above-identified International Patent Application is also described generally below preliminarily to and in connection with the discussion of the method of the present invention.

Incorporated into the current hardware and firmware design of the i2i product family is a series of firmware counting mechanisms, capable of monitoring (and of disabling) the transfer of various types of media files between devices. Also included in the hardware design is a secure Internet interface capable of connecting the device to a server via a PC, allowing the monitoring and updating of these counters.

Managing Transfers and Transfer Costs: The inventive i2i device described in the above-identified previously filed International Patent Application, and which enables easy transfer (wired or wireless) of content between portable media devices, stores “credit” for authorizing an individual to transfer content between two portable media devices (for example an IPOD® to another IPOD®) without having to use a standard computer system as the Credit Vendor. This method provides mechanisms for transferring either DRM content or non-DRM content, or both. (IPOD® is a registered trademark of Apple, Inc., of Cupertino, Calif.)

However, currently there are no means to transfer DRM content from one device to another, as the encryption scheme used for DRM protection frequently uses the target device serial number as an input to the encryption algorithm. Non-DRM and non-copyrighted material can generally be shared without cost, but multimedia content protected by copyright that cannot be shared under standard fair-use legal exemptions generally calls for the payment of a royalty fee for any reproduction or copying. To address this issue, under the inventive system a user can download “credits” to the i2i device. These credits enable legal transfers of copyrighted material through a program which establishes a prepayment scheme for transferring credits and an allocation of those prepayments to actual royalties paid out to copyright holders.

There are three forms and methods for transferring credits, including: First, a “DRM” credit system may be employed, which applies to files protected by some form of Digital Rights Management, and under which scheme a prepayment is arranged by a Credit Vendor with a DRM source company to create “virtual credits” for various types of DRM material. The virtual credits are mediated by secure digital tokens using a crypto-verification methodology passed from servers on the Internet to the i2i device electronically. If a suitable credit is available in the i2i device, a protected track is read from the source unit and re-authorized for the destination player via a crypto methodology (decryption/re-encryption) which consumes the virtual credit. The track is then copied to the target unit where it will be accessible by virtue of the aforementioned authorization process. The user purchases the required credits on the authorized Credit Vendor web site and the i2i device transfers them into itself when it is connected to the Credit Vendor server. The Credit Vendor is responsible for paying royalties to the appropriate DRM source companies in accordance with the credit purchase.

Next, a “Copyright” credit system may be employed, wherein a user purchases credits on a Credit Vendor web site and transfers them into the i2i device in the same manner as described with respect to the DRM credit.

Finally, there is provided a method for effecting a “Generic Transfer” credit, which applies to transfers not involving one of the other two types.

Other novel capabilities and features characteristic of the inventive method, together with further objects and advantages thereof will be better understood from the following description considered in connection with the accompanying drawings.

### BRIEF DESCRIPTION OF THE DRAWINGS

FIG. 1 is a block diagram showing the software and data architecture of an exemplary i2i device employed to carry out the inventive method of managing protected file transfers between portable multimedia devices, namely an IrDA beaming apparatus;

FIG. 2 is a block diagram showing transfer device hardware implementing the transfer system of FIG. 1;

FIG. 3 is a block diagram showing the software and data architecture of an alternative embodiment of the inventive system, namely an internal memory transfer system;

FIG. 4 is a block diagram showing hardware implementing the method of FIG. 3;

FIG. 5 is a block diagram showing the software and data architecture of an external memory transfer system;

FIG. 6 is a block diagram showing the hardware for implementing the system of FIGS. 5;

FIG. 7 is a block diagram showing the software and data architecture for a direct-connection method of making digital file transfers;

FIG. 8 is a block diagram showing the associated hardware thereof;

FIG. 9 is a block diagram showing the software and hardware employed in an RF analog streaming apparatus; and

FIG. 10 is a schematic block diagram showing the environment and configuration of the method to manage file transfers of protected files of the present invention.

### BEST MODE FOR CARRYING OUT THE INVENTION

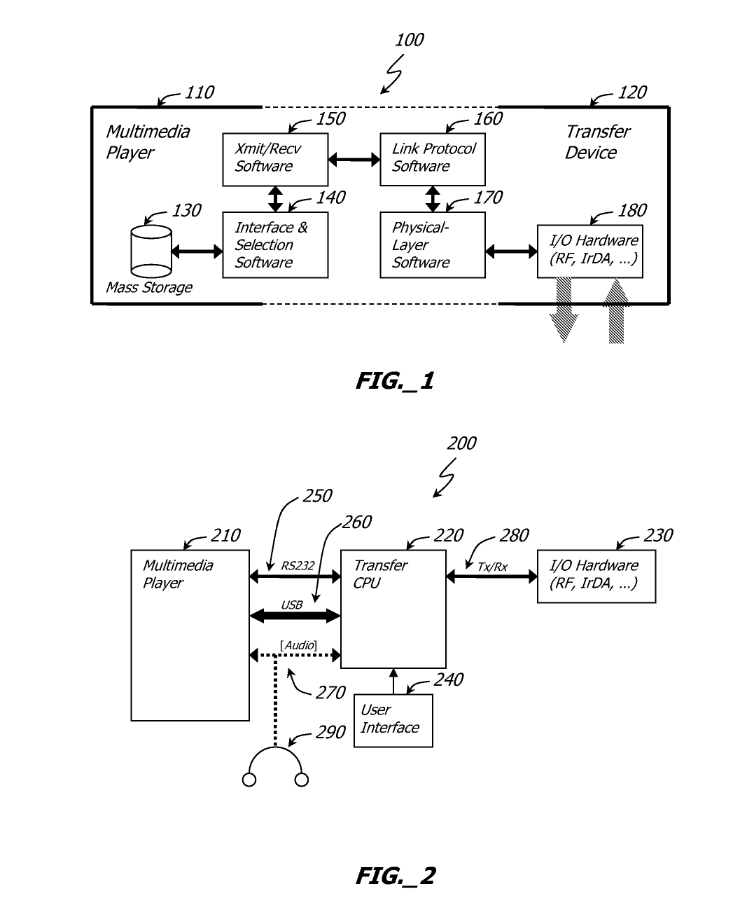

Referring first to FIGS. 1-9, there is illustrated the exemplary i2i devices that may be employed with the method of the present invention. These devices effect either wired or wireless transfer of content or data between multimedia players. In respect of FIGS. 1-8, even numbered drawings show software and data architecture for transfer/streaming systems, while each of the odd numbered drawings show complementary hardware for the respective preceding drawing. FIGS. 1, 3, 5, and 7 are block diagrams showing the software and data architecture of a transfer and streaming method and apparatus for use in the present invention. These views show the functional software blocks and the flow of data distributed between a multimedia player and a transfer device. In these apparatus, all the software modules are contained within a physically discrete “transfer” device. The transfer device includes a simple interface to the multimedia player to extract the digital content. Depending on the architecture of a particular multimedia player, one or more of the software blocks may be incorporated into the CPU in the player. However, regardless of where the processing takes place, the functionality is the same.

FIGS. 2, 4, 6, and 8 are block diagrams showing the hardware and interfaces included in such a transfer device. There are small variations in the system depending on the specific embodiment involved.

IrDA Beaming: Referring to FIGS. 1 and 2, there is shown an IrDA beaming transfer method and apparatus. In this approach, classic PDA beaming strategy is employed, via IrDA or FIR, but applied in an innovative fashion to multimedia players. Referring first to FIG. 1, the transfer system 100 comprises a multimedia player 110 joined with the transfer device hardware 120. The interface and selection software 140 running on or interacting with the multimedia player identifies a content file residing on the mass storage 130 of the multimedia player. The interface and selection software 140 extracts the file with a high-speed data interface, USB in the case of most players. At the interface software level 140 it interacts directly with the mass storage 130 via FAT [File Allocation Table] file system and MSC [Mass-Storage Compliant] or MTP [Media Transfer Protocol] protocols. (FAT file system and MSC protocols are merely examples of various file system and access protocols that may be employed.) The content next passes the data to Transmit/Receive software 150, which breaks the content down into packets and formats it for the IrDA protocol. The IrDA Link-Access Protocol [IR-LAP] software 160 is quite modest. It identifies a recipient in line-of-sight view of the optical transceiver, and establishes a link with it. With this link established, it transmits the data packets through the physical-layer software 170 to modulate the emitter for the IrDA transceiver. The receiving end uses exactly the same elements in reverse. The IR-LAP 160 establishes the connection and mediates the data transfer, which is ultimately written to the player's mass storage 130. A final function of the interface software 140 is to write the file in the correct directory, with the correct file name, and, in the case of certain players, to insert metadata about the file and content in a database on the player, all so that the multimedia player will recognize the content file for playback.

Referring next to FIG. 2, there is illustrated in block diagrammatic form the hardware 200 for the transfer device of FIG. 1. The transfer CPU 220 is the processing element inside the transfer device and carries out the different software tasks in the architecture of FIG. 1. For instance, the selection software 140 communicates with the player 210 to select a particular content file from the mass storage. It uses either the RS232 serial interface 250 if present (notably in the case of an IPOD®). The USB interface 260, by way of the interface software 140 in FIG. 1, accesses the files in the player 210 via FAT/MSC/MTP or other file system and access protocol as described above. The transfer button 240 represents a single button or a more elaborate user interface to select the content file to transfer. Then, by way of the other software elements described above in FIG. 1, the transfer CPU sends the content in packets 280 via the IrDA transceiver 230 to the connected player. For the receiver function, the pass through the hardware is the same in reverse.

RF Transfer: Another method of effecting file transfers between multimedia playback devices is also depicted by FIG. 1 and FIG. 2, is the RF transfer strategy. This is generally identical to the IrDA/FIR “beaming” approach, except that the medium is RF. The content data is modulated onto a radio carrier in one of several possible bands, including but not limited to 400 MHz, 800 MHz, 900 MHz, 2.4 GHz. The choice of band is determined by government regulations in the intended region of use, and as necessary to avoid local interfering sources of ambient RF energy. Since the RF signal will reach any receiving device within range, the link access protocol 160 in FIG. 1 must be adapted to identify and select the intended recipient. This can involve a user-interface operation where the potential recipients are prompted for acceptance of the link, and the sender's device displays a list of potential recipients so the operator may choose the desired one. After the link is established, selection and extraction of the content data 140, formatting, transmission and reception of the packet data 150 are carried out in conventional means. The packet protocol used may be the same as or different from that used in the IrDA/FIR “beaming” approach. The main difference reflects the fact that the data is modulated onto an RF carrier rather than onto an infrared light beam.

RF Streaming: Yet another approach is shown in FIGS. 1 and 2, this being an RF “live” streaming (broadcast) approach. In this embodiment, the content is extracted via the multimedia player analog interfaces (audio/video/etc.) 140, digitized and formatted as a packet 150, modulated onto the RF carrier 170, and transmitted in a broadcast fashion through the RF transmitter 180. The extraction of analog data is depicted in FIG. 2 by the analog “audio” path 270. In this system the link access protocol 160 may assign the transmission to an individual recipient as described in the “RF Transfer” approach, above, or else the transmitter may broadcast the signal to any and all recipients with a modest, transparent link access protocol or none at all. In this broadcast model, the user interface 240 may be a simple transmit/receive switch and channel selection. On the receiving end, the process happens in reverse. The user interface 240 selects the receive mode, and the CPU 220 activates the RF receiver 230 and sets the frequency. Then the data is demodulated 170, depacketized 150, and the analog signal is reconstituted through a DAC or Codec internal or external to the CPU 220 through the interface software 140. The analog signal from the receiver 270 routes to a headphone for local listening. It can also route to line inputs 270 on the destination multimedia player if it has recording capabilities.

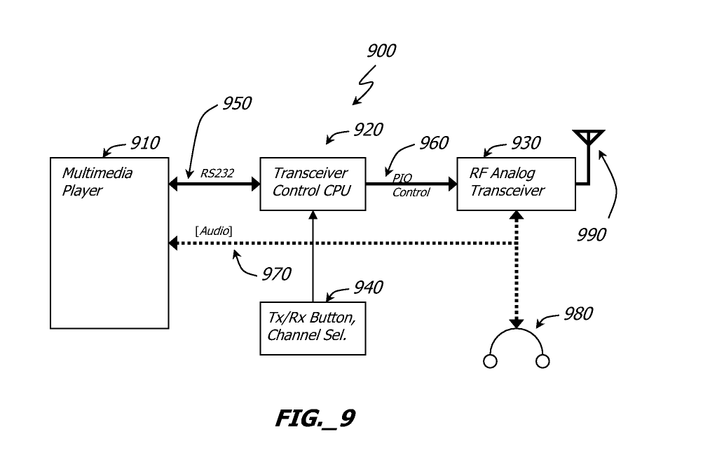

RF Analog Streaming: An alternative method is shown in FIG. 9. This system employs RF analog streaming with a very simple software architecture involved purely in controlling the tuning and operation of RF analog subsystems in the transceiver hardware. The user interface 940 selects the transmit mode, and the CPU 920 activates the RF transmitter and sets the frequency to the channel set by the user interface 940. Analog audio coming from the multimedia player headphone or line-out port 970 feeds into the RF modulator in the transceiver 930, and is then transmitted from the antenna 990. On the receiving end, the user interface 940 selects the receive mode, and the CPU 920 activates the RF receiver and sets the frequency. Analog audio demodulated from the receiver routes to a headphone for local listening. It can also route to line inputs 970 on the multimedia player if it has recording capabilities.

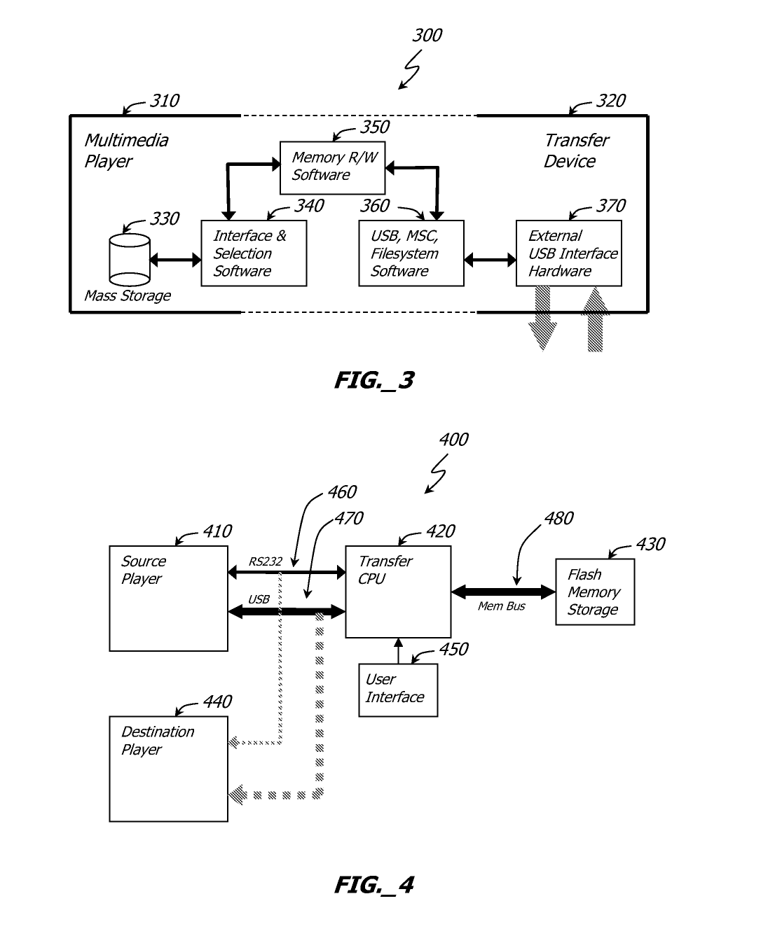

Internal-Memory Transfer: Still another multimedia file transfer system is illustrated in FIGS. 3 and 4, utilizing an internal-memory transfer approach. Referring now particularly to FIG. 4, the content data is extracted from a source player 410 and stored in flash memory 430 internal to the transfer device through a serial or parallel memory bus 480. The content selection process and interface 340 to extract the content data in FIG. 3 is identical to any of the other approaches described herein, including that previously described in reference to the interface 140 of FIG. 1. The scope and complexity of the user interface 450 depends on the multimedia player resources for selecting transfer content. Once extracted, the content data is written to flash memory and later retrieved by a memory R/W software module 350. To effect the transfer of the content data to another player, the transfer device must be physically detached from the source player 410 and attached to a destination player 440. Then via the USB interface 370 and 470, and the file system and protocol software 360, the device transfers the content to the mass storage of the destination player, integrating it into the destination player file system or database so as to be recognizable and “playable” by the player.

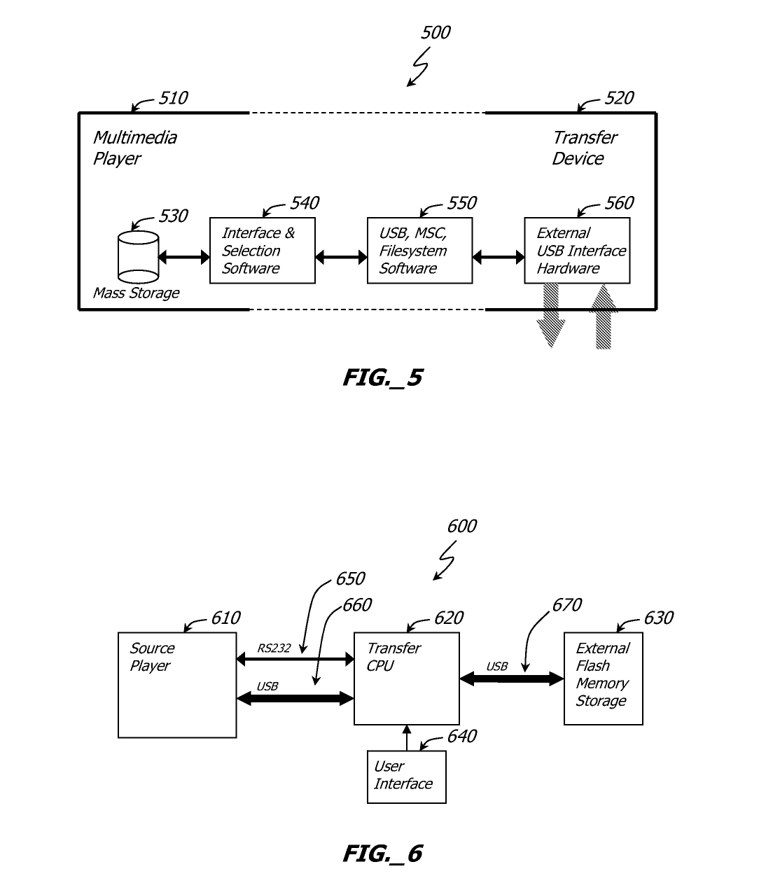

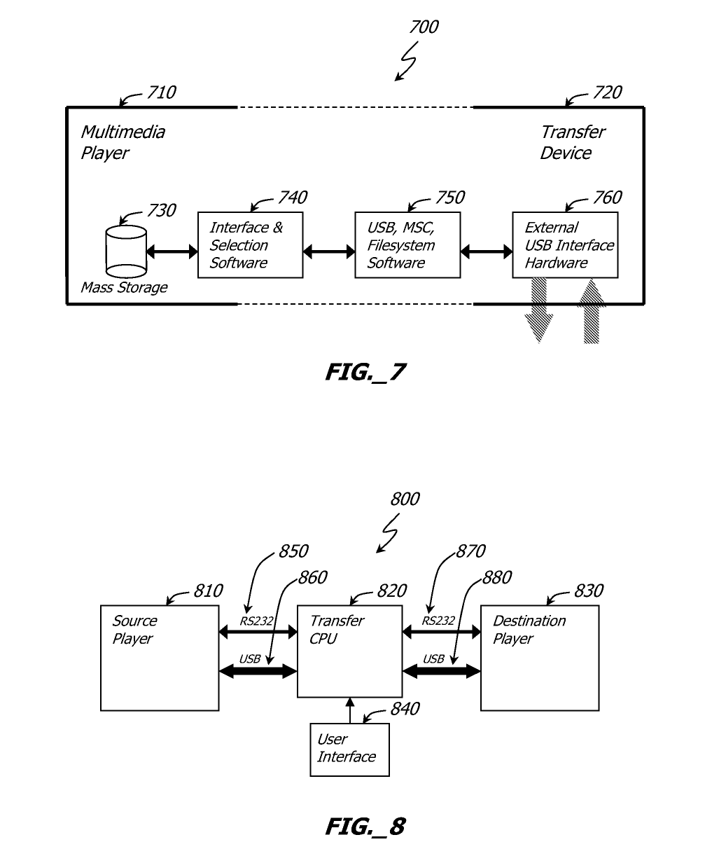

External-Memory Transfer: In still another approach, shown in FIGS. 5 and 6, the system employs an external-memory for content data transfer. FIG. 5 shows the relatively simple architecture of this system. It has no internal flash memory storage for the content, but rather depends on an external flash USB “drive” accessory. The software architecture includes the standard interface and selection module 540 to extract the content, and it then employs software for a USB flash “drive,” MTP/MSC or other protocol, and FAT or other file system 550 to interface to the external drive on the USB port 560. The hardware architecture 600 utilizes the standard interface 640 from the transfer device CPU 620 to the player 610 via USB 660 and possibly RS232 serial 650 for certain players. The scope and complexity of the user interface 640 depends on the multimedia player resources for selecting transfer content. The external USB interface 670 may be shared on a hub with the “internal” USB interface 660 for the player content extraction. The user attaches a USB flash drive to the external USB interface port, selects content and initiates transfer to the USB flash drive with the user interface 640. The user may then provide the flash drive to another user having another transfer device. The second user attaches the flash drive to the USB port on his or her own transfer device and initiates the transfer of the content to a multimedia player using the user interface 640.

Direct Interconnect: In yet another approach, shown in FIGS. 7 and 8, the system employs a direct-connection approach. A source player 810 and a destination player 830 are directly connected to the transfer device 720, which transfers the content from the mass storage 730 of the source player to the mass storage of the destination player. The hardware block diagram 800 depicts this symmetrical transfer method, while the software/data flow block diagram 700 represents it asymmetrically from the point of view of the source player. It hides the USB, MSC, and file system on the multimedia player 710 side. If the multimedia player operating system were open to third party development, the transfer device functionality could be integrated to a great degree (if not totally) into the source player. Regardless, the architecture 700 is generally simple. The content originates in the mass storage 730 of the source player 710. Interface and selection software 740 lets the user choose the content to be transferred. Interface and selection software 740 accesses the content file through USB/MSC/MTP/file system, then immediately copies it using the same software, OS, and protocol elements 750 through the USB hardware 760 to the mass storage 830 of the destination player.

FIG. 8, showing the hardware architecture 800, provides a more concrete view of this method. It is seen that both the source and the destination multimedia players are connected to the transfer device CPU 820 via USB 860 and 880 for the mass-storage access, and potentially via RS232 serial communications 850 and 870 for handshaking and/or selection functions. Once the selection is made, a user interface control 840 initiates the transfer directly from one player 810 to the other 830.

Although this approach can conceivably be performed currently with a conventional home computer and two cables, and although it has been implemented with bulky standalone devices with cables, the innovation in these approaches resides in integrating the player-interface connectors directly into the transfer device. This creates one compact package with no cables or extra parts to carry or potentially lose. The convenience is a defining feature for the target market, and unique in the art. Using these methods, an accessory with minimal user interface of its own allows direct transfer of content data from one multimedia player to another. This is especially well adapted for use with the widely accepted IPOD®. However, the same accessory used with other portable multimedia players (PMPs) will employ the same inventive methods. In the case of such alternative PMPs, the user interface techniques and precise role of the communication interfaces will vary.

As noted previously, however, there remains a need for a method to transfer DRM content from one multimedia player device to another. When multimedia content protected by copyright can only be shared under an appropriate royalty payment scheme, in a preferred embodiment of the present invention, a user can download “credits” to an i2i device. The credits enable legal transfers of copyrighted material through a program which calls for a prepayment for the transfer credits and an allocation of those prepayments to actual royalties paid out to copyright holders.

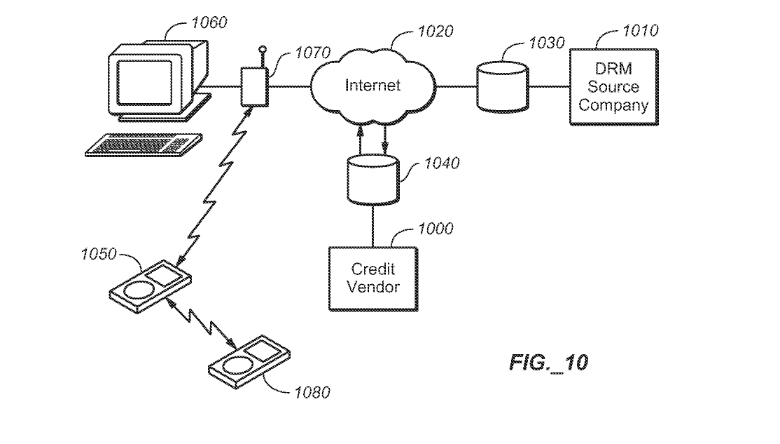

Referring next to FIG. 10, there are three possible forms to manage the transfer of credits authorizing the transfer of protected files and ensuring the payment of appropriate royalty fees. The first is “DRM” credit, which applies to files protected by some form of

Digital Rights Management. Under this scheme, a prepayment is arranged by a Credit Vendor 1000 with a DRM source company 1010 to create virtual credits for various types of DRM material. The virtual credits are mediated by secure digital tokens using a crypto-verification methodology, which is then passed from server sources on the Internet 1020—i.e., DRM source company server 1030 to the Credit Vendor server 1040—and then to the source i2i device 1050 electronically, either via a personal computer 1060 or directly through a wireless network 1070, in the event the source i2i device is a Wi-Fi enabled device and is enabled for Internet connectivity. When connected, if a suitable credit is available in the source i2i device, a protected track is read from the source i2i device and re-authorized for the target i2i device via a crypto methodology (decryption/re-encryption) which consumes the virtual credit. The track is then copied to the target i2i device 1080 where it will be accessible by virtue of the aforementioned authorization process. The user purchases the required credits on the authorized Credit Vendor web site and the i2i device transfers them into itself when it is connected to the Credit Vendor server. The Credit Vendor then pays royalties to the appropriate DRM source companies in accordance with the credit purchase.

The second form of credit is a “Copyright” credit. The user purchases these credits on the Credit Vendor web site as with DRM credits, and similarly transfers them into the source i2i device. Assuming the user's source i2i device has sufficient credits, it will transfer a non-DRM file (e.g., .MP3, .MPEG, and non-DRM .ACC) from a source to a destination player. During the process, the i2i device records identifying information about the track or file from ID3 or similar information tags to its nonvolatile memory. The next time the i2i device is connected to the Credit Vendor server, it matches the saved tag info to a database of known copyrighted material. Based on the match, the Credit Vendor server allocates the appropriate copyright royalty to the appropriate party, and it instructs the i2i device to deduct the appropriate number of credits. The Credit Vendor then pays royalties to the copyright holder based on this allocation.

The final form of credit is “Generic Transfer” credit. This type of credit applies to transfers not requiring one of the other two types. This type is expandable for many future uses. It allows a Credit Vendor to monitor non-DRM/non-copyright transfer activity. It also encourages more frequent connections of the i2i device to the Credit Vendor's servers and promotes user visits to the web site to recharge the Generic Transfer credits as well as the royalty-based ones.

The user of an i2i device must visit the Credit Vendor i2i web site and the device must connect to the server first for initial activation and later with some regularity to recharge credits. In order to encourage frequent user visits to the Credit Vendor i2i web site and to keep the cost of the credits reasonable, the web site will mediate promotional activities to help subsidize the cost of the credits.

The foregoing disclosure is sufficient to enable those with skill in the relevant art to practice the invention without undue experimentation. The disclosure further provides the best mode of practicing the invention now contemplated by the inventor.

While the particular method herein disclosed in detail is fully capable of attaining the objects and providing the advantages stated herein, it is to be understood that it is merely illustrative of the presently preferred embodiment of the invention and that no limitations are intended concerning the detail of the method steps, other than as defined in the appended claims. Accordingly, the proper scope of the present invention should be determined only by the broadest interpretation of the appended claims so as to encompass obvious modifications as well as all relationships equivalent to those described in the specification.

What is claimed as invention is:

1. A method of using a computer to ensure appropriate royalty payments to Copyright Owners when DRM files are transferred between portable media devices, the method comprising the steps of:
(a) providing at least two i2i devices, including at least one source i2i device and a target i2i device, the source i2i device having a file transfer counting mechanism for monitoring and disabling the transfer of digital files between portable digital media devices, and further including hardware for providing a secure Internet interface capable of connecting the source device to a Credit Vendor server via a network-connected computer, thus facilitating the purchase and storage of credits for authorizing a specific number of DRM file transfers, as well as monitoring and updating of the file transfer counter;
(b) prepaying by the Credit Vendor to a DRM File Source Company to obtain virtual credits for transferring DRM files;
(c) connecting the source i2i device to the Credit Vendor server via a global computer network, such as the Internet, and effecting a purchase and download of one or more of the virtual credits, which then authorize and enable the transfer of content between the source i2i device and a target i2i device without the use of a standard computer system;
(c) effecting payment from the Credit Vendor to the DRM File Source Company for the virtual credits downloaded to the source i2i device; and
(d) at will transferring a file from the source i2i device to a target i2i device.

2. The method of claim 1, wherein the virtual credits are mediated by secure digital tokens using a crypto-verification methodology, which is then passed from server sources on the Internet to the source i2i device electronically, whereby when a suitable credit is available in the i2i device, a protected track is read from the source i2i device and re-authorized for the target i2i device via a crypto methodology (decryption/re-encryption) which consumes the virtual credit, and whereby the file is then copied to the target i2i device where it may be accessed through the authorization process.

3. The method of claim 1, wherein royalties due to the File Source Company are calculated using the following method steps:
(a) during the file transfer process, the source i2i device records identifying information about the track or file from ID3 or similar information tags to its nonvolatile memory;
(b) connecting the source i2i device to the Credit Vendor server and matching saved tag info to a database of known copyrighted material;
(c) allocating the appropriate copyright royalty to the appropriate copyright holder;
(d) instructing the source i2i device to deduct the appropriate number of credits;
(e) effecting royalty payments by the Credit Vendor to the copyright holder based on this allocation.

4. The method of claim 1, further including the step of monitoring non-DRM/non-copyright transfer activity by the Credit Vendor by providing Credit Vendor monitoring means.

5. A method of transferring digital multimedia content from a source i2i device to a target i2i device, wherein multimedia content protected by copyright and/or technical protection measures under the Digital Rights Management system can be shared under an appropriate royalty payment scheme, comprising the steps of:
connecting to a Credit Vendor and making a user payment to a Credit Vendor to obtain DRM virtual credits;
paying a DRM source company for authorization to share protected DRM content;
issuing DRM virtual credits from the DRM source to the Credit Vendor and storing them on a Credit Vendor server source;
connecting a source i2i device to the Credit Vendor server source via a global network;
transferring the virtual credits from the Credit Vendor server source to the user's i2i device;
reading a protected track from the source i2i device;
authorizing a selected DRM protected file for transfer to a target i2i player via a crypto methodology which consumes the virtual credit.;
copying the DRM protected file from the source i2i device to the target i2i device;
paying royalties to the appropriate DRM source companies in accordance with the DRM virtual credit purchase.

6. The method of claim 5, further including the step of:
recording identifying information about the file from ID3 or similar information tags in the source i2i device nonvolatile memory;
connecting the source i2i device to the Credit Vendor server;
matching the saved tag information to a database of known copyrighted material;
based on the match, allocating an appropriate copyright royalty to be paid to the appropriate party;
instructing the source i2i device to deduct the appropriate number of credits; and
paying royalties to the copyright holder based on the calculated allocation.
